(19) United States
(12) Patent Application Publication
(10) Pub. No.: US 2016/0186280 A1
(43) Pub. Date: Jun. 30, 2016

(54) ASSEMBLY OF HARDENED COMPONENTS AND METHOD FOR PRODUCTION

(71) Applicant: THYSSENKRUPP STEEL EUROPE AG, Duisburg (DE)

(72) Inventors: Andreas BREIDENBACH, Brühl (DE); Jörg GORSCHLÜTER, Hamm (DE); Michael BRÜGGENBROCK, Rosendahl (DE); Ralf STEGMEYER, Medebach (DE); René HAMPE, Dinslaken (DE)

(73) Assignee: THYSSENKRUPP STEEL EUROPE AG, Duisburg (DE)

(21) Appl. No.: 14/909,218

(22) PCT Filed: Jul. 30, 2014
(86) PCT No.: PCT/EP2014/066410

§ 371 Date: Feb. 1, 2016

(30) Foreign Application Priority Data
Aug. 1, 2013 (DE) 10 2013 108 265.3

(51) Int. Cl. C21D 9/00; B62D 21/00; B23K 9/16; C21D 1/18; B23K 11/08; B23K 26/21; B23K 1/00; C21D 9/50; B62D 25/04; B23K 11/10

(52) U.S. Cl. CPC C21D 9/0068; B62D 25/04; B62D 21/00; B23K 9/16; B23K 11/10; B23K 11/08; B23K 26/21; B23K 1/0008; C21D 9/50; C21D 1/18

(57) ABSTRACT

Methods for producing subassemblies comprised of at least two metal components, at least one of which is comprised of a heat-treatable steel, may involve a number of steps. For example, a thermal joining technique may be employed to join the two metal components at one or more connection points to form the subassembly. One or more regions of the subassembly may then be hardened to cause one or more of the connection points to have at least partially a hardened microstructure.

The invention relates to a method for producing a subassembly comprising at least two joined metal components, at least one of the components consisting of a heat-treatable steel, in which the components are joined to one another to form a subassembly by using a thermal joining method. The invention also relates to a subassembly comprising at least two joined metal components, at least one of the components consisting of a heat-treatable steel and the components being joined to one another to form a subassembly using a thermal joining method.

Subassemblies comprising at least two joined metal components are usually used to provide complex constructions of metal, for example steel, that cannot be produced in one piece at all, or only in a very laborious way. The components are then usually thermally welded to form a subassembly, so that an integrally joined connection with a high load-bearing capacity is produced between the parts to be joined. With the increasing demand for reducing the weight of corresponding subassemblies, for example in motor vehicle construction, heat-treatable steels that can be hardened by a thermal treatment process are used, so that very high strength values can be provided. Typical examples of corresponding heat-treatable steels are manganese-boron steels. Dual-phase or TRIP steels can likewise be hardened by a heat treatment that results in a microstructural transformation to form a hardened microstructure. After the hardening, the hardened components are usually welded to form a subassembly. However, in particular with the hardened materials, the weld seams between the components of the subassembly lead to a renewed microstructural transformation and a weakening in the region of the weld seam. In order nevertheless to provide sufficient strengths, up to now the components have been made to greater dimensions in their wall thickness, so that up to now it has not been possible to exploit the full weight saving potential of the high-strength materials used. In particular in vehicle construction, for example when providing gusset structure in the vehicle structure, there is the additional factor that the gusset structures are often exposed to high forces, so that the dimensioning of the wall thickness of the high-strength materials used is particularly critical here. However, on account of the complex geometry of the gusset structures, integral production is often ruled out because of the necessary number of forming operations. Moreover, due to the heat input, a large number of welded connections lead to a distortion in the body in white, which can only be compensated by great expenditure on equipment.

European Patent Specification EP 1 809 776 B1 discloses a method for producing vehicle components in which at least one metal sheet of a boron-alloyed heat-treatable steel is connected to a further metal sheet of a dual-phase or TRIP steel by welding and/or brazing, the connected sheets are subjected to hot forming and only the boron-alloyed part of the connection is press-hardened. Complex subassemblies, for example gusset structures in a vehicle structure with a homogeneous load absorption capacity, therefore cannot be provided by known methods, because only much lower strengths can be provided, in particular in the weld zones.

On this basis, the object of the present invention is to provide a method for producing a subassembly comprising at least two joined metal components by which a corresponding subassembly a homogeneous, high strength can be specifically set, in spite of the connecting points that are present between the individual components of the subassembly. In addition, correspondingly produced subassemblies are to be proposed.

According to a first teaching of the present invention, the object presented is achieved by the subassembly being hardened in certain regions after the joining, so that at least one of the joined connection of the subassembly has at least partially a hardened microstructure. As a difference from the methods known from the prior art, the subassembly is first produced from the corresponding components by thermal joining and subsequently subjected as a whole to a hardening process. As a result, the joints that are present are also hardened, so that the subassembly altogether has a homogeneous load absorption capacity or a homogeneously distributed strength. The weight reduction potential of the heat-treatable steels used, for example a manganese-born steel, can be fully exploited by the method according to the invention, since in particular the wall thicknesses of the components used no longer have to be made to match the strength of the welds. According to the invention, this is so because the welds have an at least partially a hardened microstructure and consequently contribute to the overall strength of the subassembly. Apart from welding, such as for example shielded arc welding, laser welding and laser hybrid welding, brazing also comes into consideration as a thermal joining process, since this can also reduce the strength of the parts to be joined on account of the heat effect and a subsequent microstructural transformation. The components may for example be joined or welded with an overlap or a butt joint, by for example spot welding, step seams and/or (continuous) weld seams.

According to a first refinement of the method, the components of the subassembly are produced by at least one cold forming process. Coming into consideration as cold forming methods are for example bending, deep drawing, stretching, stretch forming, stamping or forming with active media.

According to a further embodiment, before the hardening, the subassembly is preferably heated, at least in certain regions, to a temperature above the Ac₁ temperature point, preferably above the Ac₃ temperature point, of the heat-treatable steel to be hardened of one component of the subassembly or of all the components of the subassembly, and is cooled at a defined cooling rate, so that an at least partially hardened microstructure is produced. The specific transformation of the austenitic structure that exists above the Ac₁ temperature, preferably above the Ac₃ temperature, of the respective material into a martensitic structure has the effect that the strength of the subassembly is significantly increased. This of course also applies to the regions of the joined connections, which likewise at least partially form a martensitic structure. As already stated, to this extent the welds consequently likewise have high strength values.

During the hardening of the subassembly, it is additionally possible to make allowance for different loads occurring on the subassembly in later use by a proportion of hardened microstructure that is adapted to the loads occurring and is optionally varied region by region being produced in certain regions in the subassembly during the hardening. As a result it is possible to provide the subassembly with different regions that provide different strengths, and are consequently optimally adapted to the particular application. For example, the application may require that the subassembly must have on the one hand a ductile, softer region and on the other hand a high-strength region. With the method according to the present invention, this can be independently set, independently of the position of the respective joined connections between the components of the subassembly.

According to a further refinement, the strength of the subassembly to be produced can be set particularly precisely by the hardening taking place in a temperature-controlled hardening tool, with which cooling rates of the subassembly that vary region by region can be achieved by tool temperatures that vary region by region. Variation of the cooling rate allows the formation of the martensitic structure to be influenced. It is therefore easily possible by varying tool temperatures to set the cooling rate to the desired proportion of martensitic structure in the region. It goes without saying that a substantially constant cooling rate over the entire subassembly can also be achieved by the temperature-controlled hardening tool.

Alternatively, according to a further refinement, the subassembly to be produced may be differingly heated region by region, in order to set different strengths in the subassembly, regions in which lower strengths are to be set for example not being heated above the Ac₁ temperature point of the heat-treatable steel to be hardened of a component of the subassembly or of all the components of the subassembly. The differingly heated subassembly is transferred into a hardening tool and hardened in the regions in which an austenitic structure has formed as a result of the heating.

According to a further refinement of the method, during the hardening, the subassembly is hot-formed and/or calibrated in the hardening tool. This refinement exploits for example the fact that an austenitic structure can undergo forming more easily at a temperature above the Ac₁ temperature, preferably above the Ac₃ temperature, of the material in a warm state. In addition, it is easily possible to introduce deformations over more than one component, for example beads, stamped formations or other secondary forming elements, into the subassembly. An additional calibrating step allows a subassembly with particularly small dimensional tolerances to be provided after the hardening.

The subassembly is preferably produced by thermally joining at least one profile to a further component. To enable them to be used, profiles, in particular partially closed profiles, must often be thermally joined to further components, so that subassemblies comprising a profile connected to a further component by thermal joining profit especially from the method. This is so because the subassembly including the joined profile can be easily provided with a homogeneous strength profile.

According to a further refinement of the method, this applies in particular whenever a gusset structure of at least two profiles is produced as the subassembly and the gusset structure of the profiles is at least partially hardened. The gusset structures of the profiles often represent the regions in which the joined connections are arranged and consequently have influenced the dimensioning of the wall thicknesses of the gusset structures. For example, corresponding gusset structures are required in particular in motor vehicles.

Therefore, according to a further embodiment of the method, the subassembly is preferably an A, B oder C pillar of a motor vehicle into which regions with varying strengths are introduced by the hardening step. As a result, it is easily possible to adapt the subassembly to the loads occurring in the particular application. Thus, for example, the roof region and the middle region of a B pillar is provided with a microstructure of maximum strength, whereas a ductile B pillar foot can absorb impact energy.

According to a further refinement of the method according to the invention, it is also possible to create a situation allowing separation of the subassembly, for example a profile of the subassembly, to be facilitated by a soft region with lower strength being produced in the subassembly between two regions with a hardened microstructure. The soft, ductile region may be provided for example in a B pillar, which can then be removed more easily by rescue teams in the event of an accident.

Finally, a gusset structure in a frame structure of a motor vehicle is preferably produced as a subassembly, in particular a gusset structure of a roof frame consisting of a profile-like roof frame, a roof cross-member profile and/or a pillar profile. The frame structure of a motor vehicle, for example the roof frame, must absorb and divert very high forces, in particular in the gusset structures, so that here the high-strength, hardened microstructure can be used to obtain a significant weight reduction. The critical thermal joints, for example weld seams, especially have a hardened microstructure, so that they can contribute to a high load absorption capacity.

According to a second teaching of the present invention, the object presented above is achieved by a subassembly comprising at least two joined metal components, at least one of the components consisting of a heat-treatable steel and the components being joined to one another to form a subassembly by using a thermal joining method, the object being achieved by the subassembly having been hardened at least in certain regions after the joining and at least one joined connection having an at least partially hardened microstructure.

The subassembly according to the invention differs from the conventional subassemblies in that the thermal joints, which are produced by welding or brazing, in particular laser welding, are likewise provided with a hardened microstructure by the subsequent hardening process. This means that the joining zones can also contribute to the desired load absorption capacity. The hardening of the subassembly in certain regions is therefore carried out for example over more than one component, so that the regions of the joined connections and also regions of both components profit from the microstructural transformation into a hardened microstructure.

According to a further refinement of the subassembly, it comprises at least one profile or a gusset structure of at least two profiles. Profiles, at least partially closed or else open profiles, are often used for absorbing high forces. They are generally connected to one another by way of thermal joints, in particular weld seams. The gusset structures represent regions that are subjected to particularly high loads, for example of a vehicle frame structure, since in the gusset structures the forces of a number of profiles have to be absorbed and passed on, so that the provision of a hardened microstructure in the joined connections offers a particularly great weight saving potential here.

In order to provide in a B pillar of a motor vehicle a region in which the B pillar can be divided without making any great sacrifices in terms of its load-bearing function in the motor vehicle, the subassembly has a soft region with lower strength between two hardened regions. This non-hardened region may serve the purpose for example of separating a B pillar at this point in the event of an accident, in order to rescue the occupants. In addition, there are still other application possibilities in which an arrangement of a softer, more ductile microstructure between two hardened regions may be necessary.

According to a further refinement, with preference the subassembly is an A, B or C pillar of a motor vehicle and has regions with varying strengths. The advantages of correspondingly designed A, B or C pillars of a motor vehicle have already been explained above.

According to a further refinement of the subassembly, it has at least one gusset structure in a frame structure of a motor vehicle. As already stated above, the gusset structure in a frame structure of a motor vehicle are exposed to particularly high forces. The welds with reduced strengths that are usually present are not present in the embodiment of the subassembly according to the invention, so that a significant reduction in the wall thickness is possible with an identical force absorption capacity. A great weight saving potential is made possible as a result.

The invention is to be explained below on the basis of exemplary embodiments in conjunction with the drawing, in which:

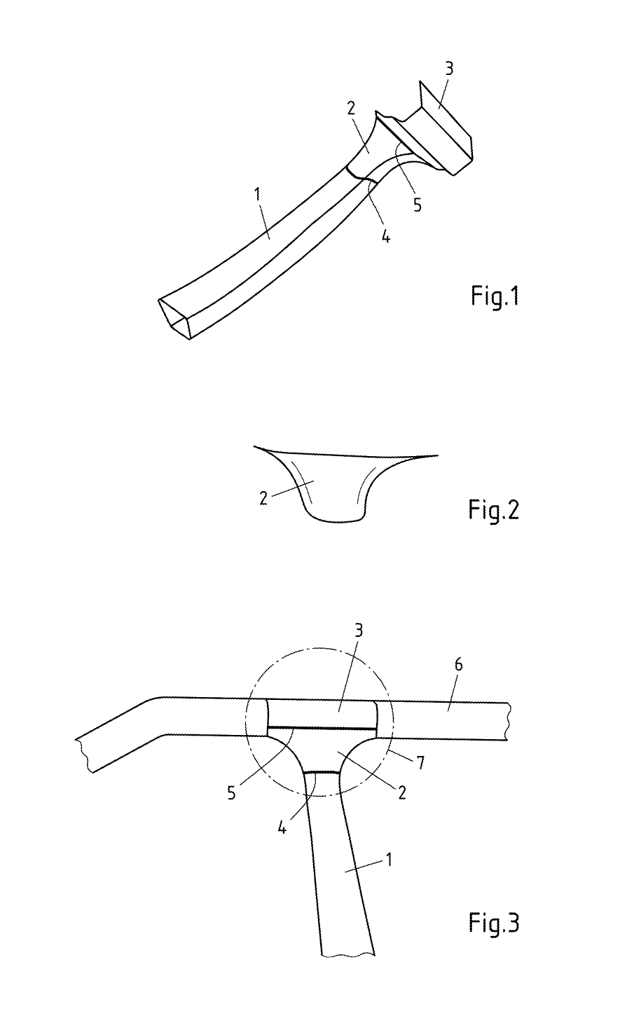

FIG. 1 shows a first exemplary embodiment of a subassembly consisting of three components in a perspective, schematic view,

FIG. 2 shows a component of the subassembly in a perspective view in an individual view,

FIG. 3 shows the exemplary embodiment of the subassembly from FIG. 1 in the state in which it is fitted in the motor vehicle,

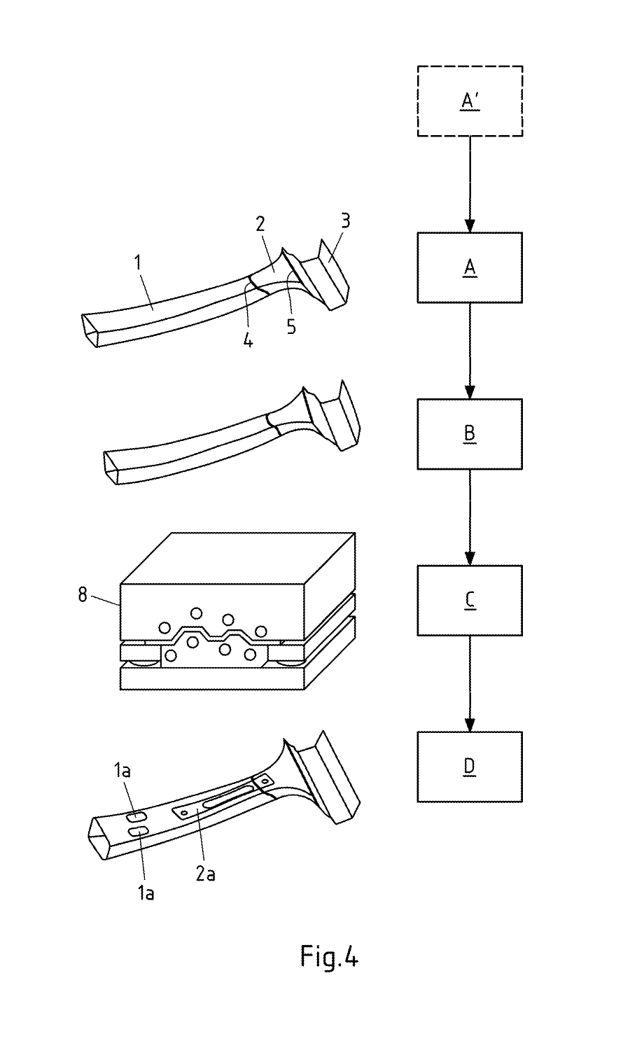

FIG. 4 schematically shows the method steps of an exemplary embodiment of the method according to the invention for producing a subassembly and

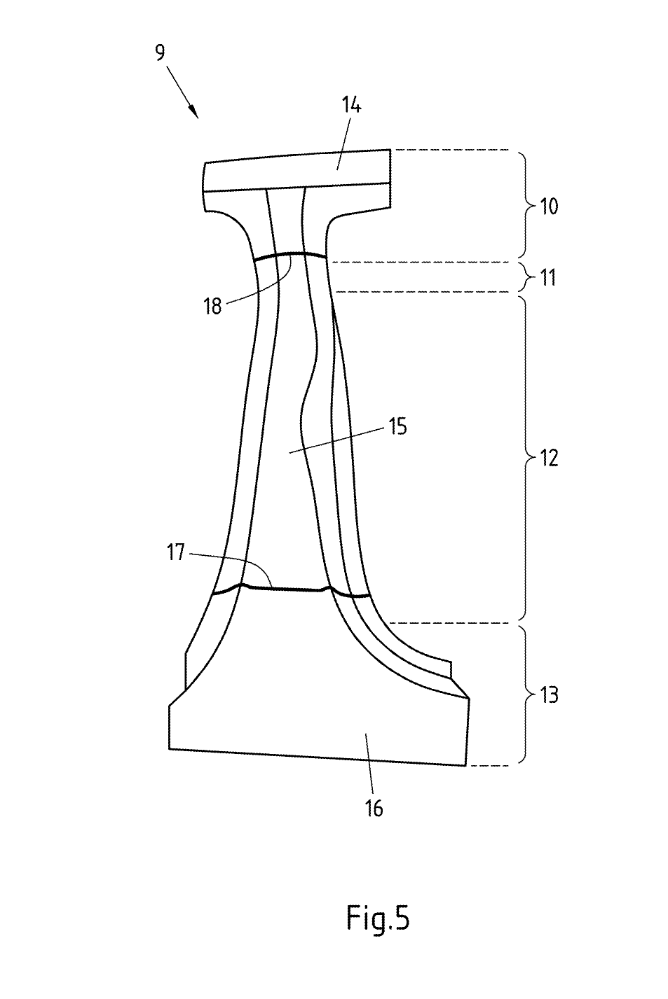

FIG. 5 shows a second exemplary embodiment of a subassembly in the form of a B pillar of a motor vehicle in a side view.

In FIG. 1, an exemplary embodiment of a subassembly comprising a closed profile 1, a connection piece 2 and an open profile 3 is shown in a perspective, schematic view. At least one of the components, for example the closed profile 1, consists of a heat-treatable steel and can be hardened by a heat treatment. In the present case, the components 1, 2 and 3 are the parts of a B pillar and all consist of a heat-treatable steel, for example of a boron-alloyed steel, preferably a steel of the type 22 MnB 5. The components 1, 2 and 3 have been produced in advance by cold forming processes, for example drawing, bending or a forming process involving active media. Apart from monolithic semifinished products, the use of semifinished products of multi-layered metallic composite materials is also conceivable, in particular at least one of the layers consisting of a heat-treatable steel.

The connection piece 2 has both with respect to the open profile 3 and with respect to the closed profile 1 joining seams 4, 5, by way of which the connection piece 2 connects the two profiles 3 and 1 to one another.

FIG. 2 shows once again the connection piece 2, which, like the profile 1 and the profile 3, has for example been produced by a cold forming process.

In FIG. 3, the subassembly from FIG. 1 is schematically shown in its position in the motor vehicle. Together with the subassembly formed as a B pillar, comprising the components 1, 2 and 3, the roof frame 6 represents a gusset structure 7, which connects the roof frame 6 to the B pillar consisting of the components 1, 2 and 3. Since the B pillar illustrated in FIG. 3 has been produced by the method according to the invention, it preferably has a region consisting of a hardened microstructure in the region of attachment to the roof frame 6. The regions of the B pillar that are illustrated in FIG. 3 may for example all consist of a hardened microstructure. On account of the production method according to the invention, the weld seams 4, 5 in particular similarly have a hardened microstructure in the welding zones, so that a gusset structure with maximum strength can be provided.

FIG. 4 schematically shows method steps A′, A, B, C and D of an exemplary embodiment of the method and the associated perspective representations of a subassembly given by way of example in the form of a B pillar. First, in method step A, the subassembly consisting of a closed profile 1, a connection piece 2 and an open profile 3 is thermally joined by a welding method to form a single subassembly. Use of a thermal brazing method is also conceivable. In method step B, the subassembly thus produced is then subjected to a heating process, in which the subassembly is heated, in the present example completely, to a temperature above the Ac₃ temperature point of the respective material. As a result, the microstructure of the subassembly is transformed completely into austenite. After being placed into the hardening tool 8, the subassembly is hot-formed and rapidly cooled, according to method step C, so that in method step D a completely hardened subassembly has been produced, the weld seams 4, 5 of which likewise have a hardened microstructure.

In the hardening tool 8, which is merely schematically represented, beads 2a and recesses 1a over more than one component are for example introduced into the closed profile 1 and press-hardened. The joining seams, which likewise have an austenitic microstructure above the Ac₃ temperature of the respective material, can be transformed into a hardened microstructure in the hardening tool 8 by rapid cooling, for example at a cooling rate of over 27 K/s for manganese-boron steels. A calibration of the subassembly preferably additionally takes place here in method step C, so that a high-strength subassembly with hardened joining seams can be provided in method step D. In the preceding, schematically represented method step A′, prior to their assembly, the components 1, 2 and 3 can be transformed by a cold forming process to such an extent that they yield almost the final form of the finished subassembly, can be joined to one another. It goes without saying that other forming methods for providing the components 1, 2 and 3 are also conceivable.

In FIG. 5, a further exemplary embodiment of the subassembly according to the invention is illustrated, likewise formed as a B pillar. The B pillar 9 from FIG. 5 consists of the components 14, 15 and 16, which are connected to one another by way of the weld seams 17 and 18. According to the teaching of the present invention, the subassembly produced in this way is then heated to a temperature above the Ac₃ temperature of the material of the components. The proportion of hardened microstructure can then be adapted to the present application in the hardening tool by way of differingly temperature-controlled regions. Thus, for example, the exemplary embodiment illustrated in FIG. 5 of a subassembly has, independently of the position of the respective weld seam 17, 18, seen in the longitudinal direction, regions 10, 11, 12 and 13 over more than one component that have to some extent different proportions of hardened microstructure. Thus, the regions 10 and 12 are provided with a proportion of hardened microstructure that is as high as possible, so that, on account of their extremely high strength, these regions protect the occupants of a motor vehicle as well as possible in the event of a lateral collision. The B pillar foot 13 is usually made more ductile, which can be set by an increased tool temperature in this region. The lower cooling rate has the effect that, in spite of the heating to the Ac₃ temperature, there is no formation, or only a slight formation, of a hardened microstructure. The region 11, which is arranged between the hardened regions 10 and 12, is likewise provided with a soft or ductile microstructure, which can likewise be achieved by the specific setting of the tool temperature. This region serves the purpose of enabling rescue teams to separate the B pillar more easily in the event of an accident. If the region 11 of the B pillar 9 is made appropriately small, there is little influence on the overall strength of the B pillar 9.

With the method according to the invention, at least more complicated subassemblies consisting of high-strength materials can be produced, while also providing strength values in the joints that are no lower.

1.-17. (canceled)

18. A method for producing a subassembly comprising at least two metal components, wherein at least one of the at least two metal components comprises a heat-treatable steel, the method comprising:
using a thermal joining technique to join the at least two metal components at one or more connection points to form the subassembly; and
hardening the subassembly in one or more regions after the at least two metal components are joined to cause at least one of the one or more connection points to have at least partially a hardened microstructure.

19. The method of claim 18 further comprising using at least one cold forming process to produce the at least two metal components of the subassembly.

20. The method of claim 18 further comprising:
heating at least a portion of the at least one of the at least two metal components comprising the heat-treatable steel to a temperature above an Ac₁ temperature point of the heat-treatable steel before the hardening; and
cooling the at least the portion of the at least one of the at least two metal components comprising the heat-treatable steel at a defined cooling rate so as to produce an at least partially-hardened microstructure.

21. The method of claim 18 further comprising:
hardening a first region of the subassembly to have a hardened microstructure configured for loads occurring in the first region of the subassembly; and
hardening a second region of the subassembly to have a hardened microstructure configured for loads occurring in the second region of the subassembly, wherein the loads occurring in the first region of the subassembly are different than the loads occurring in the second region of the subassembly, wherein the hardened microstructure of the first region is different than the hardened microstructure of the second region.

22. The method of claim 18 wherein the hardening occurs in a temperature-controlled hardening tool that is configured to apply different cooling rates to different regions of the subassembly.

23. The method of claim 22 wherein the hardening further comprises at least one of hot-forming or calibrating the subassembly in the temperature-controlled hardening tool.

24. The method of claim 18 wherein the using the thermal joining technique to join the at least two metal components comprises thermally joining at least one profile to one of the at least two metal components.

25. The method of claim 18 further comprising producing a gusset structure of at least two profiles as part of the subassembly, wherein the gusset structure of the at least two profiles is at least partially hardened.

26. The method of claim 18 wherein the subassembly is an A, B, or C pillar of a motor vehicle, wherein the hardening further comprises introducing regions with varying strengths into the A, B, or C pillar.

27. The method of claim 18 further comprising producing a first region in the subassembly disposed between a second region and a third region, wherein the second and third regions have hardened microstructures, wherein a microstructure of the first region is softer and more ductile than the hardened microstructures of the second and third regions.

28. The method of claim 18 further comprising producing a gusset structure in a frame structure of a motor vehicle as part of the subassembly.

29. A subassembly comprising:
a first metal component comprising a heat-treatable steel; and
a second metal component joined to the first metal component at one or more connection points by way of a thermal joining technique,
wherein the first and second metal components form a subassembly, wherein one or more regions of the subassembly are hardened after the first and second metal components are joined such that the one or more regions of the subassembly have at least partially hardened microstructures.

30. The subassembly of claim 29 wherein at least one of the first metal component or the second metal component has regions with a proportion of hardened microstructure adapted for loads to be experienced in those regions.

31. The subassembly of claim 29 wherein the subassembly comprises either at least one profile or a gusset structure comprising at least two profiles.

32. The subassembly of claim 29 wherein a first region is disposed between a second region and a third region in the subassembly, wherein the second and third regions have hardened microstructures, wherein a microstructure of the first region is softer and more ductile than the hardened microstructures of the second and third regions.

33. The subassembly of claim 29 wherein the subassembly is an A, B, or C pillar of a motor vehicle and comprises regions with varying strengths.

34. The subassembly of claim 29 wherein the subassembly has at least one gusset structure in a frame structure of a motor vehicle.
